(19) United States
(12) Patent Application Publication
(10) Pub. No.: US 2020/0209086 A1
(43) Pub. Date: Jul. 2, 2020

(54) Differential Pressure Sensor and Fabrication Method Therefor

(71) Applicant: Formosa Measurement Technology Inc. Ltd., Zhubei City, Hsinchu County 302 (TW)

(72) Inventors: Chin-Fu Hsu, Zhubei City (TW); Yuan-chieh Chen, Zhubei City (TW); Chih-yung Lin, Zhubei City (TW); Shih-pin Chen, Zhubei City (TW)

(21) Appl. No.: 16/603,270

(22) PCT Filed: Apr. 7, 2017
(86) PCT No.: PCT/CN2017/079675

§ 371 Date: Dec. 27, 2019

(51) Int. Cl. G01L 9/02; G01L 9/00

(52) U.S. Cl. CPC G01L 9/02; G01L 9/0073

(57) ABSTRACT

A differential pressure sensor, wherein a gas pipeline (12) is formed in an IC carrier plate (10) and two air holes (13) in communication with the gas pipeline (12) are arranged on the top surface of the IC carrier plate (10). A pressure sensing chip (30) is integrated with one of the air holes (13) on the IC carrier plate (10), and an upper cover (40) is adhered and combined on the top surface of the IC carrier plate (10); two cavities (411) are arranged on the upper cover (40) and correspond to the positions of the two air holes (13), and two air pipes (42) respectively connected to the cavities (411) are arranged on the upper cover (40). When in use, the present invention is combined with a circuit board and guided by the two air holes (13) and the gas pipeline (12), so that the front and the back sides of the pressure sensing chip (30) simultaneously sense high-pressure gas and low-pressure gas inputted by the two air pipes (42), and the functions of electrical signal transmission and gas pressure transmission are carried out by using mature and mass-produced IC carrier plate (10) technology, thereby greatly reducing the difficulty and cost of fabrication.

### FIELD OF INVENTION

Present invention relates to a structure and a production method of a differential pressure sensor, especially to a differential pressure sensor manufactured by IC packaging technology and production method thereof.

### BACKGROUND OF THE INVENTION

Conventional differential pressure sensors must have configured with at least two pressure detecting tubes in order to connect with a high-pressure gas input and a low-pressure gas input respectively. Gases from these two pressure gas inputs are detected by the pressure detecting tubes and are transferred from an internal structure of the differential pressure sensor to a surface of a sensing film of a pressure sensor chip. The pressure sensor chip can then convert the gas pressure into electrical signals for further process and output.

Normal way of the conventional differential pressure sensor to accomplish gas pressure transmission is mainly through a package structure to guide the gas pressure toward a front side and a back side of the pressure sensor chip. This can be done by utilizing a structure combined with a Pre-Molded wire support and a plastic structure with pressure transmission function. Another approach is to use two pressure sensor chips to measure the differential pressure between the high-pressure gas input and the low-pressure gas input to successfully detect pressure difference therebetween.

A conventional way to produce the combined structure of aforementioned Pre-Molded wire support and the plastic structure is normally in a high cost because this kind of pressure guiding structure are produced with assembled pieces by several plastic molds. Moreover, a packaging factory must adjust a production line, equipment and production method according to a shape of the wire support as required which makes it became more and more difficult to make. The way of using two pressure sensor chips is also considered no better or had no improvement because the high production cost. Hence, it is eager to have a differential pressure sensor manufactured by IC packaging technology and production method thereof that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the shortcomings of the conventional differential pressure sensor for hard to produce and high cost of the plastic molds. The present invention is presented with new packaging technology to economically and technically solving the signal transmission and gas pressure problems of conventional differential pressure.

In the first aspect of the present invention, a differential pressure sensor comprises:

an IC board, a signal processing chip, a pressure sensing chip and a lid. The IC board comprises a substrate body with substrate sheets laminated together. A gas channel is formed inside the substrate body. Two air holes are penetrated through an upper surface of the substrate body and connected with the gas channel. Several welding spots are formed on the upper surface of the substrate body and connected with a conductive circuit.

The signal processing chip is attached with the substrate body and connected with the conductive circuit.

The pressure sensing chip comprises a upper side and a bottom side. The pressure sensing chip is attached with the substrate body by covering one of the air hole. The pressure sensing chip is connected with the conductive circuit for transmitting a signal detected by its upper side and bottom side to the signal processing chip through the conductive circuit.

The lid comprises a combined block where a bottom side of the combined block is firmly attached with the top surface of the substrate body. Two cavities are formed on a bottom side of the combined block corresponded to positions of the two air hole. The pressure sensing chip is placed in one of the cavity. The other cavity is connected with the air hole. Two air pipes are extruded from the combined block and each air pipe has an air tunnel formed inside. Each air tunnel is connected with the cavities respectively.

In accordance, a chip placement room is configured to form between the two cavities. The signal processing chip is placed inside the chip placement room. A pressure balance hole is form at a top of the chip placement room.

In accordance, the gas channel is a long shape channel extending straightly inside the substrate body. Two air holes are connected with two ends of the gas channel. The signal processing chip is mounted on the top surface of the substrate body between two air holes.

In accordance, the substrate body comprises a top substrate sheet and a bottom substrate sheet laminated together. A long groove is formed on the bottom substrate sheet. The gas channel is formed by a bottom side of the top substrate sheet laminated with the long groove of the bottom substrate sheet. Two air holes are formed by penetrating the top substrate sheet towards the gas channel.

In accordance, the substrate body comprises a top substrate sheet, a middle substrate sheet and a bottom substrate sheet laminated together. A long hole is formed on the middle substrate sheet. The gas channel is formed by a bottom side of the top substrate sheet laminated with the long hole of the middle substrate sheet and the bottom substrate sheet. Two air holes are formed by penetrating the top substrate sheet towards the gas channel.

Another aspect in accordance to the present invention, a method of producing a differential pressure sensor comprises steps of:

providing an IC board with an internal gas channel connected with two air holes; several welding spots are formed on the IC board and each welding spot are connected with a conductive circuit; packaging a signal processing chip on the IC board; the signal processing chip is connected with the conductive circuit; packaging a pressure sensing chip on a top surface of the IC board; the pressure sensing chip covers one of the air hole; the pressure sensing chip is connected with the signal processing chip through the conductive circuit; and attaching a lid with two cavities on the top surface of the IC board; the two cavities are connected with two air pipes extruded from the lid; the pressure sensing chip that covers one of the air hole is placed inside one of the cavity; another cavity is connected with the other air hole to obtain the differential pressure sensor.

In accordance, when the substrate body of the IC board comprises a top substrate sheet and a bottom substrate sheet, the gas channel is obtained by forming a long groove on the bottom substrate sheet which a depth of the long groove is not greater than a thickness of the bottom substrate sheet; attaching the top substrate sheet on the bottom substrate sheet as a bottom surface of the top substrate sheet and the long groove of the bottom substrate sheet will form into the gas channel; penetrating two air holes vertically from the top substrate sheet towards the bottom substrate sheet corresponded to the two ends of the gas channel; forming several welding spots around two sides of the substrate body and these welding spots are connected with the conductive circuit to obtain the IC board.

In accordance, when the substrate body of the IC board comprises a top substrate sheet, a middle substrate sheet and a bottom substrate sheet, the gas channel is obtained by forming a long hole on the middle substrate sheet which a depth of the long hole is equal to a thickness of the middle substrate sheet; attaching the top substrate sheet and the bottom substrate sheet on opposite sides of the middle substrate sheet as a bottom surface of the top substrate sheet and the long hole of the middle substrate sheet and a top surface of the bottom substrate sheet will form into the gas channel; penetrating two air holes vertically from the top substrate sheet towards the middle substrate sheet corresponded to the two ends of the gas channel; forming several welding spots around two sides of the substrate body and these welding spots are connected with the conductive circuit to obtain the IC board.

In accordance, the present invention has the following advantages. When using the present invention, the IC board of the present invention is welded with a circuit board. The welding spots of the present invention is electrically connected with the circuit board. A high pressure gas and a low pressure gas from a high pressure gas source and low pressure gas source are input to the present invention by the two air pipe. The upper side of the pressure sensing chip can detect the high pressure gas being input from one of the air pipe. The low pressure gas otherwise is input via another air pipe and is detected by the bottom side of the pressure sensing chip passing through the two air holes and gas channel. The pressure sensing chip can detect both the high pressure gas and the low pressure gas by its upper side and bottom side at the same time. The gas pressures will be transferred into a signal and transmitted to the signal processing chip for further processing. After the signal is processed by the signal processing chip, it will be transmitted to the circuit board via welding spots.

The significant feature of the present invention is that as a single component, the IC board of the present invention can take in charge for the electrical connection and act as a gas pressure transmission channel. While carrying the signal processing chip and the pressure sensing chip, the IC board can electrically connected these two chips for outputting the signal processed by the signal processing chip through the welding spot. By using the lid and gas channel of the IC board, the pressure sensing chip of the present invention also has the ability of gas pressure transmission by simultaneously detecting the high pressure gas and the low pressure gas input from tow air pipe into two cavities. Since the IC board of the present invention doesn't need to be assembled by several plastic pieces, the present invention has advantage in reducing production cost. Moreover, IC board's mass production is a very mature technology now and then. The process of manufacturing IC board is a lot easier, uncomplicated and cost saving than producing it by conventional injection molding. Many of the attendant features and advantages of the present invention will become better understood with reference to the following detailed description considered in connection with the accompanying figures and drawings.

### BRIEF DESCRIPTION OF THE DRAWINGS

FIG. 1 is an exploded view of the first embodiment in accordance with the present invention;

FIG. 2 is a illustrate diagram of the first embodiment in accordance with the present invention;

FIG. 3 is a cross-section diagram of the first embodiment in accordance with the present invention;

FIG. 4 is a block diagram of the first embodiment in accordance with the present invention;

FIG. 5 is a production flow chart for producing the first embodiment in accordance with the present invention;

FIG. 6 is a cross-section diagram of the second embodiment in accordance with the present invention; and

FIG. 7 is a production flow chart for producing the second embodiment in accordance with the present invention.

### REFERENCE SIGNS IN ACCORDANCE TO THE FIGURES OF THE PRESENT INVENTION

| | | | |
|---|---|---|---|
| 10 | IC board | 11 | Substrate body |
| 111 | Substrate sheet | 112 | Long groove |
| 113 | Long hole | 12 | Gas channel |
| 13 | Air hole | 14 | Welding spot |
| 15 | Conductive circuit | 20 | Signal processing chip |
| 30 | Pressure sensing chip | 31 | Upper side |
| 32 | Bottom side | 40 | Lid |
| 41 | Combined block | 411 | Cavities |
| 412 | Chip placement room | 413 | Pressure balance hole |
| 42 | Air pipe | 421 | Air tunnel |

### DETAILED DESCRIPTION OF THE PREFERRED EMBODIMENTS

The steps and the technical means adopted by the present invention to achieve the above and other objects can be best understood by referring to the following detailed description of the preferred embodiments and the accompanying drawings. Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

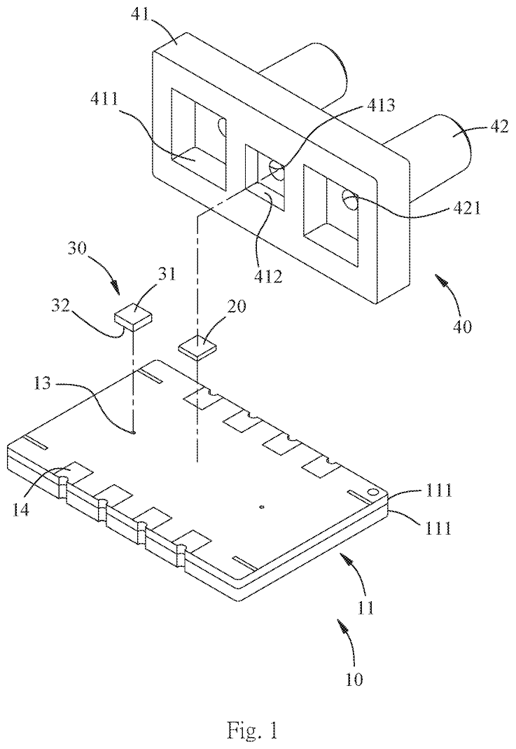

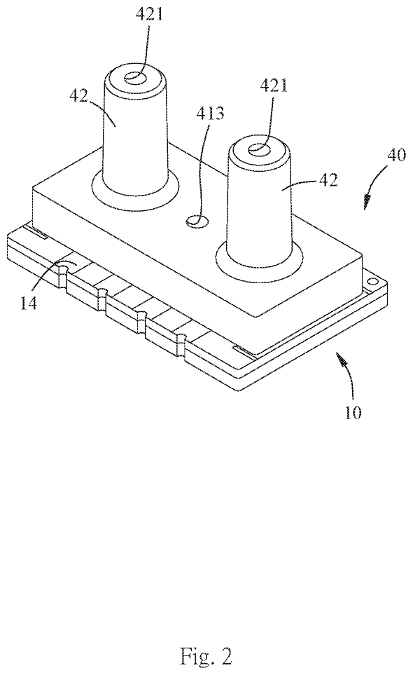

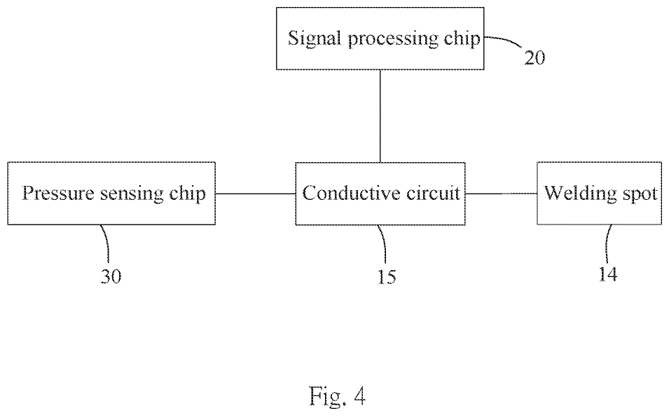

With reference to FIGS. 1 to 4, a first embodiment of the present invention is presented. A differential pressure sensor comprises an IC board 10, a signal processing chip 20, a pressure sensing chip 30 and an upper lid 40. The signal processing chip 20 and the pressure sensing chip 30 are mounted on the IC board 10 respectively.

The IC board 10 comprises a substrate body 11. The substrate body 11 comprises at least two layers of laminated and combined substrate sheets 111. In this preferred embodiment, the substrate body 11 comprises two laminated substrate sheets 111 (hereinafter a bottom substrate sheet and a top substrate sheet). An upper side of the bottom substrate sheet 111 comprises a long groove 112 concaved in the middle. The long groove 112 is extended in a left-right direction on the bottom substrate sheet 111. When the top and bottom substrate sheets 111 are laminated, a planed surface of a bottom side of the top substrate sheet 111 and the long groove 112 of the bottom substrate sheet 111 will form a gas channel 12. At two ends of the gas channel 12, two air holes 13 are vertically penetrated through an upper side of the top substrate sheet 111. These two air holes 13 are configured at a left and right side of an upper side of the substrate body 11 and communicated with both ends of the gas channel 12 respectively. Several welding spots 14 are arranged on a front and rear sides around the substrate body 11. The substrate body 11 is provided with a conductive circuit 15 connected with the welding spots 14.

The signal processing chip 20 is encapsulated (or packaged) in a middle of two air holes 13 at an upper side of the substrate body 11. The signal processing chip 20 is connected with the conductive circuit 15.

The pressure sensing chip 30 has an upper side 31 and a bottom side 32 for detecting gas or air pressure from difference sources. The pressure sensing chip 30 is also encapsulated (or packaged) on the upper side of the substrate body 11. One of the air hole 13 is hence covered by the bottom side 32 of the pressure sensing chip 30. Thus, the pressure sensing chip 30 can detect an air or gas pressure that come from the gas channel 12 by its bottom side 32. The pressure sensing chip 30 is also connected with the conductive circuit 15. The pressure sensing chip 30 transmits a signal detected by its upper side 31 and bottom side 32 to the signal processing chip 20 through the conductive circuit 15. After the signal processing chip 20 processed the signal, the signal will be transmitted to each welding spot 14 through the conductive circuit 15. The signal processed by the signal processing chip 20 hence can be output from the IC board 10.

The lid 40 comprises a component (hereinafter combined block 41) for combining with the IC board 10. The combined block 41 is a plastic block having its shape corresponded to a shape of the IC board 10. In a preferred embodiment, the combined block 41 and the IC board are both in rectangle shape. A bottom side of the combined block 41 is firmly attached or adhesive with the upper side of the substrate body 11. Two cavities 411 (herein after the first and the second cavities from the left to the right direction) are configured on a left side and a right side of the bottom side of the combined block 41 corresponded to the positions of the two air holes 13. One of the cavity 411 (or the first cavity 411) covers the pressure sensing chip 30 which also covers one of the air hole 13. Another cavity 411 (or the second cavity 411) covers and communicates with another air hole 13 without covering by the pressure sensing chip 30. Two air pipes 42 are configured to extrude from the left side and the right side at the upper side of the combined block 41. An air tunnel 421 is formed inside each air pipe 42. Each air tunnel 421 is communicated with the first and the second cavities 411. A third cavity 412 (or a chip placement room 412) is configured to set between the first and the second cavity 411 corresponding to the position of the signal processing chip 20. The signal processing chip 20 can be placed inside this third cavity 412. A pressure balance hole 413 is formed at a top of the third cavity 412 and is communicated with the chip placement room 412. An air pressure inside the chip placement room 412 can be balanced with outside atmosphere through the pressure balance hole 413.

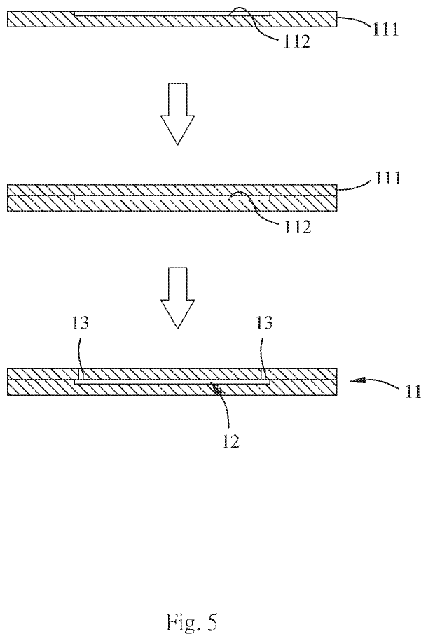

The IC board 10 in this first embodiment is a sole component which can be produced parts by parts. With reference to FIG. 5, a production method of the IC board 10 can have steps of processing the bottom substrate sheet 111 by machinery, laser, or chemical etching to obtain the long groove 112; attaching the top substrate sheet 111 on to the upper side of the bottom substrate sheet 111 to form the air channel 12; and forming two air hole 13 penetrated through the top substrate sheet 111 for communicating with the each end of the air channel 12. The air channel 12 and the air holes 13 set at each end will create a continuous air or gas pressure passage to the whole system. While processing the long groove 112, a processed depth of the long groove 112 should not be greater than a thickness of the bottom substrate sheet 111.

When using the present invention, the IC board will be welded on products, like a circuit board of a respiration meter. Each welding spot of the present invention needs to be electrically connected with the circuit board of the respiration meter. A high pressured gas and a low pressured gas are input to the present invention through the air pipes 42 respectively.

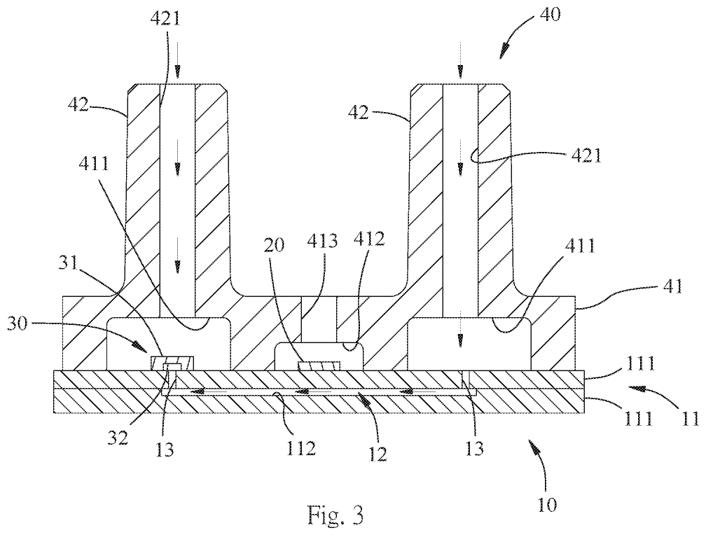

With reference to FIG. 3, the upper side 31 of the pressure sensing chip 30 can detect the pressure of the high pressure gas being input to the left side cavity 411 (or the first cavity) through the left side air channel 42. The pressure of the low pressure gas is input to the right side cavity 411 (or the second cavity) through the right side air channel 42. This low pressure gas can reach to the bottom side 32 of the pressure sensing chip 30 all the way down through the right side air hole 13 and the gas channel 12. The pressure sensing chip 30 can hence detect both high pressure gas and low pressure gas through its upper side 31 and bottom side 32. These detected high and low pressure will be transferred into the electric signal and transmitted to the signal processing chip 20 for further processing. The processed electric signal will be transmitted to the circuit board of the product through each welding spot 14.

The present invention has advantage in reducing production cost because IC board's mass production is a very mature technology now and then. The process of manufacturing IC board is a lot easier, uncomplicated and cost saving than producing it by conventional injection molding. In the present invention, the IC board 10 can take in charge for the electrical connection and act as a gas pressure transmission channel at the same time. While carrying the signal processing chip 20 and the pressure sensing chip 30, the IC board 10 can electrically connected these two chips (20, 30) for outputting the signal processed by the signal processing chip 20 through the welding spot 14. By using the lid 40 and gas channel 12 of the IC board 10, the pressure sensing chip 30 of the present invention also has the ability of gas pressure transmission by simultaneously detecting the high pressure gas and the low pressure gas input from tow air pipe 42 into two cavities 411.

The process of packaging the signal processing chip 20, the pressure sensing chip 30 and the lid 40 on the IC board 10 of the present invention is no different than the packaging process of any other conventional IC board. Since the IC board 10 is a sole component without assembly required, the final product of the present invention can be presented by simply attached the lid 40 after packaging the two chips (20, 30) on the substrate body 11. There's no need to adjust or change the existing production line, equipment or processing method of packaging IC board 10 for the factories. This provides flexibility for making the present invention and make it becomes more easy to make and cost saving.

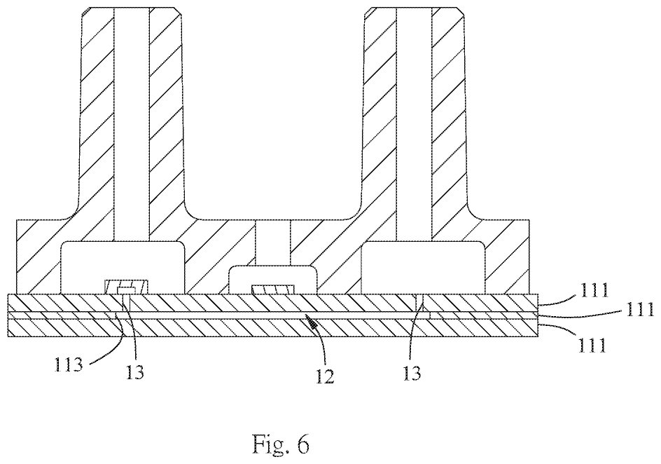

With reference to FIG. 6, the second embodiment of the present invention is presented. The substrate body 11 in this embodiment comprises three laminated substrate sheets 111 (hereinafter the upper substrate sheet, the middle substrate sheet and the bottom substrate sheet when describing). The substrate sheet 111 laminated in the middle forms a long hole 113 extending in a left and right direction. A gas channel 12 can be formed by a bottom surface of the upper substrate sheet 11, the long hole 113 and the top surface of the bottom substrate sheet 111. At the ends of the gas channel 12, two air holes vertically penetrate the upper substrate sheet 11 respectively. These two air holes are air connected and communicated with the gas channel 12. The remaining structures and how these structures working of this embodiment are as same as the structure and mechanism of the first embodiment described above. There's no need to further describe it.

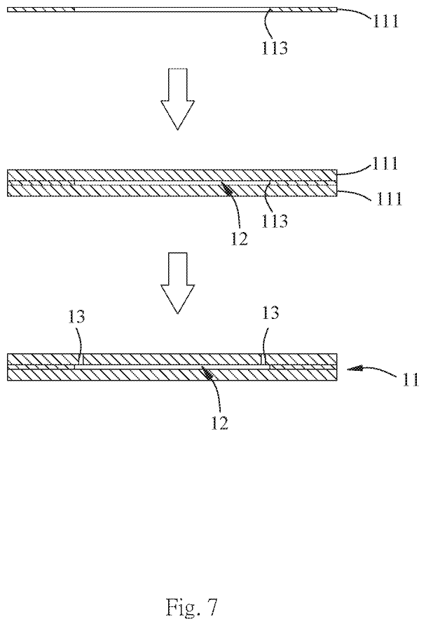

With reference to FIG. 7, it illustrates production steps of this second embodiment with three laminated substrate sheets 111. Firstly, a long hole 113 is processed and formed on the middle substrate sheet 111 by machinery, laser cutting or chemical etching. Not like the long groove 12 as mentioned above, the depth of the long hole 113 is exactly the same as the thickness of the middle substrate sheet 111 this time while processing. Then, attaching the upper substrate sheet 111 and the bottom substrate sheet 111 on the opposite sides of the middle sheet 111. The gas channel 12 will be simultaneously formed. Two air holes are further penetrated from on the upper substrate sheet toward the two ends of the long hole 113 by machinery, laser cutting or chemical etching which make these two air holes connected and communicated with the gas channel 12 to form a continuous gas pressure transmission passage.

The present invention also provides a production method of the differential pressure sensor. The production method comprises steps as follow.

Firstly, providing an IC board 10 with internal gas channel 12 where a top surface of the IC board 10 comprises two air holes 13 connected with two ends of the gas channel 12 respectively. Several welding spots are formed around two sides of the IC board 10 and these welding spots are connected with a conductive circuit 15.

A signal processing chip 20 is packaged on the IC board 10 and connected with the conductive circuit 15. A pressure sensing chip 30 is mounted on the IC board 10 by covering one of the air hole 13 and also connected with the conductive circuit 15. The pressure sensing chip 30 can detect different pressures came from different sources by its top surface and bottom surface. A signal detected by the top surface and the bottom surface of the pressure sensing chip 30 is transmitted to the signal processing chip 20 through the conductive circuit 15. After the signal being processed by the signal processing chip 20, it will be further transmitted to each welding spot 14 via conductive circuit 15. Thus, the signal processed by the present invention can be further output through the welding spots 14.

A lid 40 is prepared with concaved two cavities 411. Two air pipes 42 are extruded from the lid 40 and connected with the two cavities 41. After attaching the lid 40 with the IC board 10, the pressure sensing chip 30 can be perfectly placed in one of the cavity 411. At the same time, another cavity 411 otherwise is connected with the another air hole 13 without covering by the pressure sensing chip 30.

Before the step of providing the IC board 10, a pretreatment can be treated to the IC board for having the gas channel 12. With reference to FIG. 5, the gas channel 12 can be obtain by firstly forming the long groove 112 on the bottom substrate sheet 111 by machinery, laser cutting or chemical etching when the IC board 10 in this embodiment has two laminated layers. One should be noticed that the depth of the long groove 112 should not be greater than the thickness of the bottom substrate sheet 111 in this embodiment. Secondly, attaching or adhering the top substrate sheet 111 onto the bottom substrate sheet 111 as the bottom surface of the top substrate sheet 111 and the long groove 112 of the bottom substrate sheet 111 will form into the gas channel 12. Thirdly, penetrating two air holes 13 vertically from the top substrate sheet 111 towards the bottom substrate sheet 111 corresponded to the two ends of the gas channel 12 by machinery, laser cutting or chemical etching, the substrate body 11 of the IC board 10 will be obtained. Further by forming several welding spots 14 around two sides of the substrate body 11 and these welding spots are connected with the conductive circuit 15, the final product of the IC board in the embodiment of the present invention is finished.

With reference to FIG. 6, another embodiment for producing the IC board 10 with three laminated layers comprise firstly forming a long hole 113 on the middle substrate sheet 111 by machinery, laser cutting or chemical etching. One should be noticed that the depth of the long hole 113 should be equal or the same as the thickness of the middle substrate sheet 111. Secondly, attaching or adhering the top substrate sheet 111 and the bottom substrate sheet 111 onto the opposite sides of the middle substrate sheet 111 as the bottom surface of the top substrate sheet 111 and the long hole 113, and the top surface of the bottom substrate sheet 111 will form into the gas channel 12. Thirdly, penetrating two air holes 13 vertically from the top substrate sheet 111 towards the middle substrate sheet 111 corresponded to the two ends of the gas channel 12 by machinery, laser cutting or chemical etching, the substrate body 11 of the IC board 10 will be obtained. Further by forming several welding spots 14 around two sides of the substrate body 11 and these welding spots are connected with the conductive circuit 15, the final product of the IC board in this embodiment of the present invention is finished.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

1. A differential pressure sensor comprising:
an IC board;
a signal processing chip;
a pressure sensing chip;
a lid; wherein:
the IC board comprises a substrate body with substrate sheets laminated together; a gas channel is formed inside the substrate body; two air holes are penetrated through a upper surface of the substrate body and connected with the gas channel; several welding spots are formed on the upper surface of the substrate body and connected with a conductive circuit;
the signal processing chip is attached with the substrate body and connected with the conductive circuit;
the pressure sensing chip comprises a upper side and a bottom side; the pressure sensing chip is attached with the substrate body by covering one of the air hole; the pressure sensing chip is connected with the conductive circuit for transmitting a signal detected by its upper side and bottom side to the signal processing chip through the conductive circuit; and
the lid comprises a combined block where a bottom side of the combined block is firmly attached with the top surface of the substrate body; two cavities are formed on a bottom side of the combined block corresponded to positions of the two air hole; the pressure sensing chip is placed in one of the cavity; the other cavity is connected with the air hole; two air pipes are extruded from the combined block and each air pipe has a air tunnel formed inside; each air tunnel is connected with the cavities respectively.

2. The sensor as claimed in claim 1, wherein:
a chip placement room is configured to form between the two cavities;
the signal processing chip is placed inside the chip placement room; and
a pressure balance hole is form at a top of the chip placement room.

3. The sensor as claimed in claim 2, wherein:
the gas channel is a long shape channel extending straightly inside the substrate body;
two air holes are connected with two ends of the gas channel; and
the signal processing chip is mounted on the top surface of the substrate body between two air holes.

4. The sensor as claimed in claim 1, wherein:
the substrate body comprises a top substrate sheet and a bottom substrate sheet laminated together;
a long groove is formed on the bottom substrate sheet;
the gas channel is formed by a bottom side of the top substrate sheet laminated with the long groove of the bottom substrate sheet; and
two air holes are formed by penetrating the top substrate sheet to the gas channel.

5. The sensor as claimed in claim 1, wherein:
the substrate body comprises a top substrate sheet, a middle substrate sheet and a bottom substrate sheet laminated together;
a long hole is formed on the middle substrate sheet;
the gas channel is formed by a bottom side of the top substrate sheet laminated with the long hole of the middle substrate sheet and the bottom substrate sheet; and
two air holes are formed by penetrating the top substrate sheet to the gas channel.

6. A method of producing a differential pressure sensor having steps of:
providing an IC board with an internal gas channel connected with two air holes; several welding spots are formed on the IC board and each welding spot are connected with a conductive circuit;
packaging a signal processing chip on the IC board; the signal processing chip is connected with the conductive circuit;
packaging a pressure sensing chip on a top surface of the IC board; the pressure sensing chip covers one of the air hole; the pressure sensing chip is connected with the signal processing chip through the conductive circuit; and
attaching a lid with two cavities on the top surface of the IC board; the two cavities are connected with two air pipes extruded from the lid; the pressure sensing chip that covers one of the air hole is placed inside one of the cavity; another cavity is connected with the other air hole to obtain the differential pressure sensor.

7. The method as claimed in claim 6, wherein:
when the substrate body of the IC board comprises a top substrate sheet and a bottom substrate sheet, the gas channel is obtained by forming a long groove on the bottom substrate sheet which a depth of the long groove is not greater than a thickness of the bottom substrate sheet;
attaching the top substrate sheet on the bottom substrate sheet as a bottom surface of the top substrate sheet and the long groove of the bottom substrate sheet will form into the gas channel;
penetrating two air holes vertically from the top substrate sheet towards the bottom substrate sheet corresponded to the two ends of the gas channel;
forming several welding spots around two sides of the substrate body and these welding spots are connected with the conductive circuit to obtain the IC board.

8. The method as claimed in claim 6, wherein:
when the substrate body of the IC board comprises a top substrate sheet, a middle substrate sheet and a bottom substrate sheet, the gas channel is obtained by forming a long hole on the middle substrate sheet which a depth of the long hole is equal to a thickness of the middle substrate sheet;
attaching the top substrate sheet and the bottom substrate sheet on opposite sides of the middle substrate sheet as a bottom surface of the top substrate sheet and the long hole of the middle substrate sheet and a top surface of the bottom substrate sheet will form into the gas channel;
penetrating two air holes vertically from the top substrate sheet towards the middle substrate sheet corresponded to the two ends of the gas channel; and
forming several welding spots around two sides of the substrate body and these welding spots are connected with the conductive circuit to obtain the IC board.

9. The sensor as claimed in claim 2, wherein:
the substrate body comprises a top substrate sheet and a bottom substrate sheet laminated together;
a long groove is formed on the bottom substrate sheet;
the gas channel is formed by a bottom side of the top substrate sheet laminated with the long groove of the bottom substrate sheet; and
two air holes are formed by penetrating the top substrate sheet to the gas channel.

10. The sensor as claimed in claim 3, wherein:
the substrate body comprises a top substrate sheet and a bottom substrate sheet laminated together;
a long groove is formed on the bottom substrate sheet;
the gas channel is formed by a bottom side of the top substrate sheet laminated with the long groove of the bottom substrate sheet; and
two air holes are formed by penetrating the top substrate sheet to the gas channel.

11. The sensor as claimed in claim 2, wherein:
the substrate body comprises a top substrate sheet, a middle substrate sheet and a bottom substrate sheet laminated together;
a long hole is formed on the middle substrate sheet;
the gas channel is formed by a bottom side of the top substrate sheet laminated with the long hole of the middle substrate sheet and the bottom substrate sheet; and
two air holes are formed by penetrating the top substrate sheet to the gas channel.

12. The sensor as claimed in claim 3, wherein:
the substrate body comprises a top substrate sheet, a middle substrate sheet and a bottom substrate sheet laminated together;
a long hole is formed on the middle substrate sheet;
the gas channel is formed by a bottom side of the top substrate sheet laminated with the long hole of the middle substrate sheet and the bottom substrate sheet; and
two air holes are formed by penetrating the top substrate sheet to the gas channel.
